(19) United States
(12) Patent Application Publication
(10) Pub. No.: US 2016/0248305 A1
(43) Pub. Date: Aug. 25, 2016

(54) PRODUCTION METHOD FOR LARGE ROTOR/STATOR LAMINATIONS

(71) Applicant: Andrew L. Flaherty, Lake Zurich, IL (US)

(72) Inventor: Andrew L. Flaherty, Lake Zurich, IL (US)

(73) Assignee: TEMPEL STEEL COMPANY, Chicago, IL (US)

(21) Appl. No.: 14/631,105

(22) Filed: Feb. 25, 2015

(51) Int. Cl. H02K 15/02

(52) U.S. Cl. CPC H02K 15/024

(57) ABSTRACT

In a method for forming at least one of a circular rotor or stator lamination, at least one or two electrical strips of lamination material are provided. At least one or two of the strips are cut into segments. At least three of the segments are connected together to form a polygon having all equal sides.

### BACKGROUND

In the prior art, electrical steel in core form is available in widths up to 48 inches. Motor or generator cores have a stator and a rotor, each formed from a plurality of stack laminations referred to also herein as lamination layers. Core from widths of up to 48 inches allows for state of production in a complete round form up to that size. For larger stators, like those typically seen in large generator or motor applications, each of the lamination layers of the stator must be produced in an arc segment form.

In U.S. Pat. No. 8,082,654, incorporated herewith by reference, issued Dec. 27, 2011, inventor—Mark Bender, it was known to manufacture a lamination for a motor or generator by using a plurality of laminations to form a core of the stator, or rotor, or both stator and a rotor of a motor or generator. A material strip was provided of electrical steel having a width substantially corresponding to half of the outer diameter of the lamination to be created. Slant cuts were made along the material strip to form oppositely facing trapezoids of substantially a same area. Two of the trapezoids were joined together along a side edge of each to form a hexagon. The joining could be accomplished by a welding process. The lamination was then stamped from the hexagon.

### SUMMARY

It is an object to improve upon the process of the aforementioned '654 patent to provide a manufacturing method which utilizes relatively narrow steel strips to manufacture relatively large stator and rotor laminations and to minimize scrap in the manufacturing method.

In a method for forming at least one of a circular rotor or stator lamination, at least one or two electrical strips of lamination material are provided. At least one or two of the strips are cut into segments. At least three of the segments are connected together to form a polygon having all equal sides.

### BRIEF DESCRIPTION OF THE DRAWINGS

FIGS. 1A-1F illustrate a first exemplary embodiment of an improved production method for large rotor/stator laminations;

FIGS. 2A-2F illustrate a second exemplary embodiment of an improved production method for large rotor/stator laminations;

FIGS. 3A-3E illustrate a third exemplary embodiment of an improved production method for large rotor/stator laminations;

FIGS. 4A-4D illustrate a fourth exemplary embodiment of an improved production method for large rotor/stator laminations; and

FIGS. 5A-5D illustrate a fifth exemplary embodiment of an improved production method for large rotor/stator laminations.

### DESCRIPTION OF EXEMPLARY EMBODIMENTS

For the purposes of promoting an understanding of the principles of the invention, reference will now be made to preferred exemplary embodiments/best mode illustrated in the drawings and specific language will be used to describe the same. It will nevertheless be understood that no limitation of the scope of the invention is thereby intended, and such alterations and further modifications in the illustrated embodiments and such further applications of the principles of the invention as illustrated as would normally occur to one skilled in the art to which the invention relates are included herein.

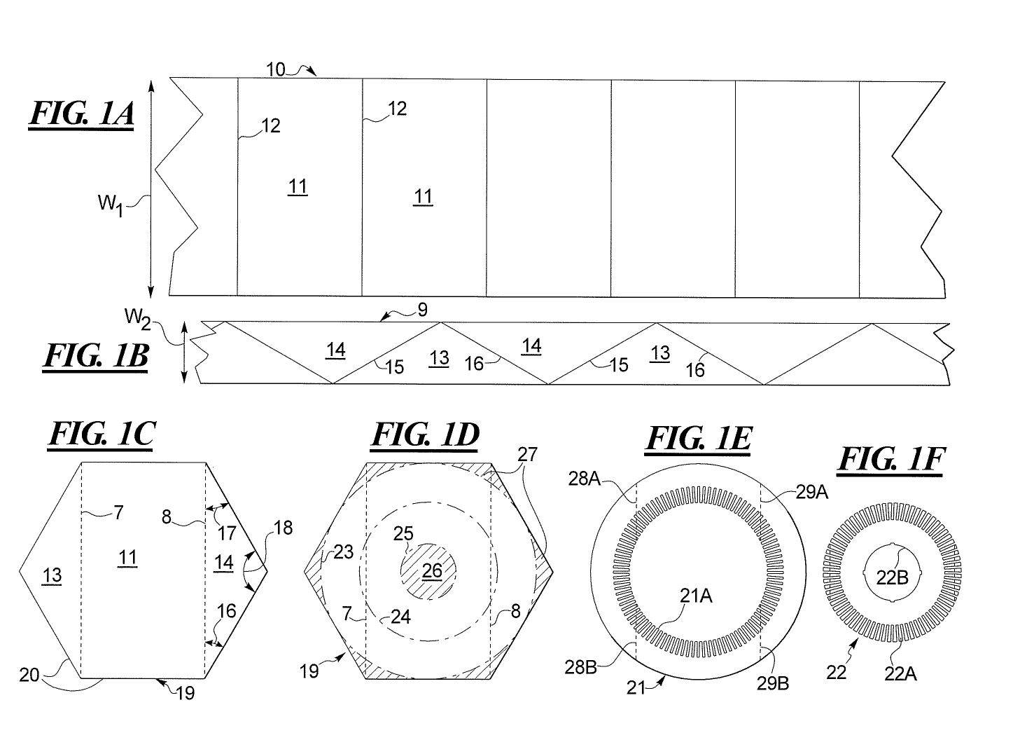

A first embodiment method for the improved production method for large rotor/stator laminations will now be described in connection with FIGS. 1A-1F.

As shown in FIG. 1A, a first strip of electrical steel 10 is cut such as by shearing to create individual equal size rectangles 11 at cut lines 12 running perpendicular to longitudinal extent of the strip 10.

An additional electrical steel strip 9 having a same or similar electrical characteristics as strip 10 is also provided. Strip 9 is cut into individual oppositely facing triangles 13 and 14 which are all identical by cutting along cut lines 15 and 16.

As illustrated in FIG. 1C, one of the rectangles 11 is attached such as by welding with two of the triangles 13 and 14 at opposite long sides of the rectangle 11. Although triangles 13 and 14 are indicated, two of the identical triangles 13 or two of the identical triangles 14 could also be used at the opposite sides. The triangles are welded together, or attached by some other technique (as is also true for the second through fifth embodiments described hereafter), to the rectangle along joint lines 7 and 8. The triangles have respective angles 16 and 17 of 30° and a large angle 18 of 120°.

An electrical steel hexagon 19 is thus formed where the six sides 20 all have an equal length. This equal length results from an appropriate choice of the dimensions of the rectangle 11 and the dimensions of the triangles 13, 14 to achieve the hexagon 19 having the equal side lengths 20. By providing equal side lengths, the hexagon 19 can accommodate a circular stamping where edges of the hexagon are substantially tangent at six edge points of the circle. Thus when stamping occurs, scrap is minimized. It should be further noted that in cutting the strips 9 and 10 substantially no scrap is created. Thus the method minimizes manufacturing cost. It should further be noted that only three pieces are used to construct the hexagon 19.

As shown in FIG. 1D, the hexagon 19 is stamped to create a stator 21 by stamping along dashed line circles 23 and 24 to create the stator 21 of FIG. 1E, and along an additional dashed line circle 25 to create a rotor 22 as shown in FIG. 1F. In this explanation it will be understood by those skilled in the art that other features of the rotor and stator such as the teeth 21A and 22A are also created by the same or separate stamping steps not described in detail here since such stamping to create teeth is well known to those skilled in the art. Waste material 26 at the center is indicated by slant lines and additional waste material 27 outwardly of the peripheral edge of the outer circle 23 is also illustrated by slant lines. The rotor has a central aperture 22b created by removal of the scrap 26 as shown in FIG. 1F.

In summary, for the first method embodiment both the rotor and the stator are created with minimal scrap and using three pieces. Although two strips 9 and 10 are shown to create the rectangles 11 and the triangles 13, 14, it is of course possible that a single strip could be used wherein both the triangles and the rectangles are cut from the same strip. However, the use of two strips as illustrated in FIGS. 1A and 1B is preferred for simplicity and for minimal or substantially no scrap. It should further be noted that the width W₁ of the strip 10 is defined by the length of the rectangle 11 used to create the hexagon 19, and the width W₂ of the strip 9 is defined by the height of the triangles 13, 14 used to form the hexagon 19. Thus relatively thin strips can be used to create a large rotor and large stator.

As further shown in FIGS. 1E and 1F, the rotor 21 has weld lines 28A, 28B and 29A, 29B corresponding to portions of the weld lines 7 and 8 in the hexagon 19.

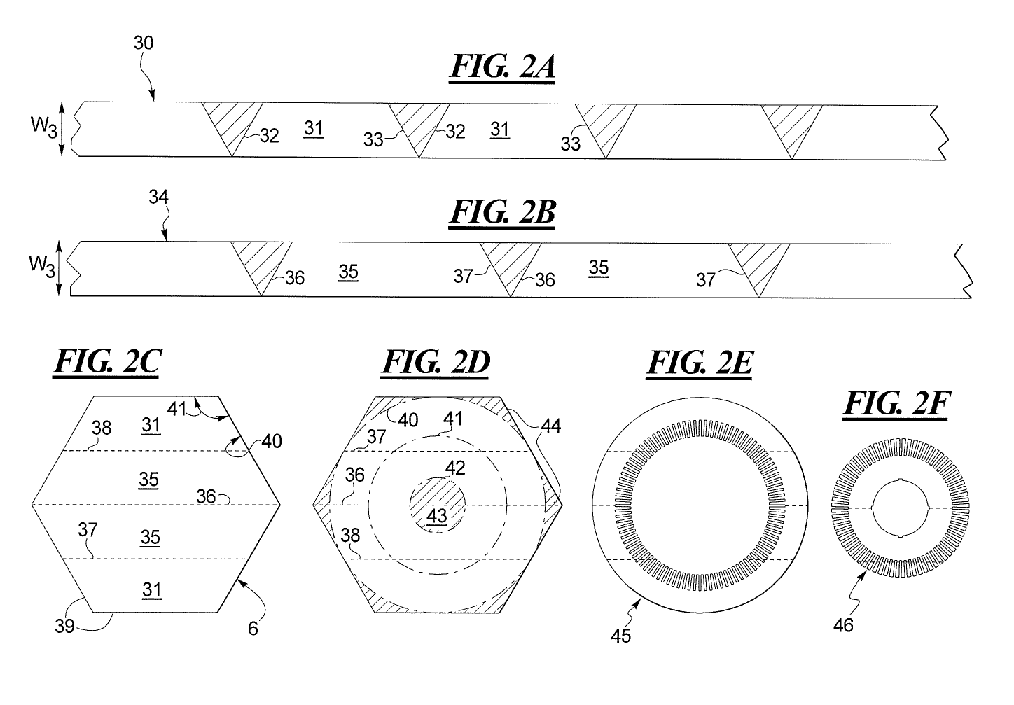

A second embodiment of the method will now be described with respect to FIGS. 2A-2F. Because of similarities between the first embodiment and the second embodiment method, many of the features already described in connection with the first embodiment will not be repeated for the second embodiment, also not for the third through fifth embodiments also described hereafter.

In FIG. 2A, a first strip 30 is provided which is cut to create individual segments each comprising a trapezoid 31 by cutting along cut lines 32 and 33. Cut lines 32 are parallel to each other and cut lines 33 are parallel to each other.

As shown in FIG. 2B, a second strip 34 is cut or sheared to create segments comprising individual trapezoids 35. Trapezoids 35 are longer than the trapezoids 31. The trapezoids 35 are created by cut lines 36, 37. Cut lines 36 are parallel to each other and cut lines 37 are parallel to each other. The width of strip 30 and the width of strip 34 are the same as indicated by width W₃ in FIG. 2A.

In FIG. 2C, two of the trapezoids 31 and two of the trapezoids 35 are shown welded along weld lines 36, 37, and 38. All of the trapezoids have the same height and the two central trapezoids 35 are longer than the two top and bottom trapezoids 31. A hexagon 6 is thus formed having six sides 39 all of equal length. The trapezoids all have internal angles 40 and 41 of 60° and 120°.

As illustrated in FIG. 2D, stamping circles indicated by dashed line circles 40, 41, and 42 are defined, with a central area within circle 42 being scrap 43. Outside the circle 40 are additional scrap areas 44 indicated by slant lines.

As indicated in FIG. 2E and FIG. 2F, a stator 45 is formed by stamping dashed circles 40 and 41, and rotor 46 is formed by stamping dashed line circles 41 and 42. Parts of the weld lines 36, 37, and 38 are visible in FIGS. 2E and 2F.

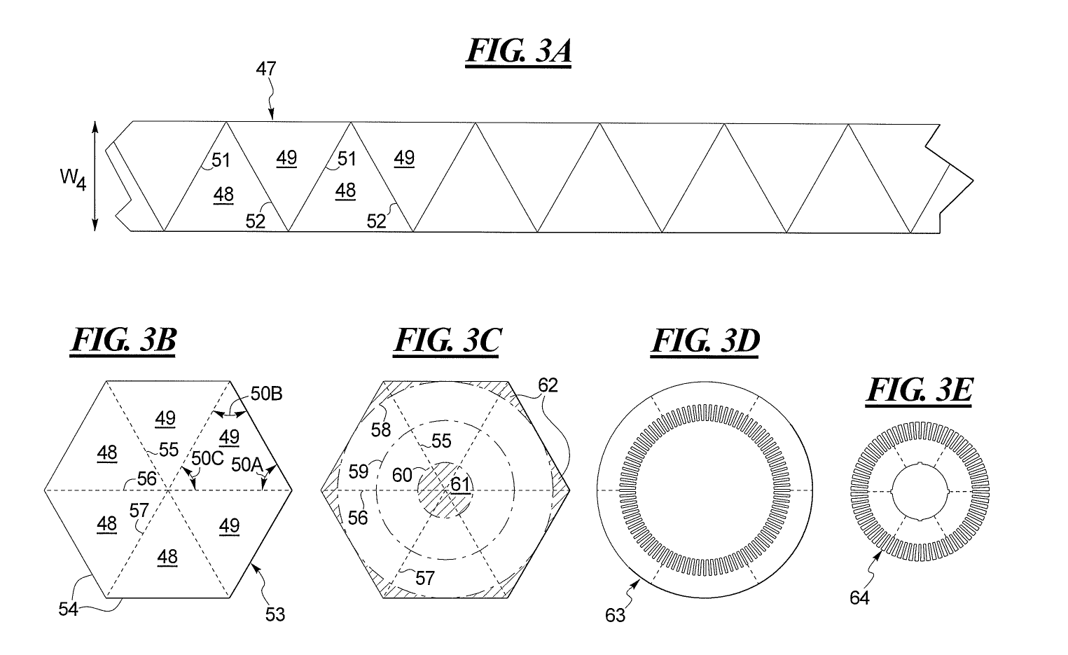

A third embodiment shown in FIGS. 3A-3E will now be explained. As shown in FIG. 3A, the strip 47 is slit or cut to create a plurality of equal segments comprising triangles 48 and 49. As shown in FIG. 3B, each triangle has equal internal angles of 60° as shown at 50A, 50B, and 50C. The triangles are created by cutting along cut lines 51 and 52. Cut lines 51 are all parallel to each other and cut lines 52 are all parallel to each other. The height of the triangles 48 or 49 defines the width W₄ of the strip 47. As may be observed, there is substantially no waste in cutting the strip 47.

As illustrated in FIG. 3B, a hexagon 53 is formed of six equal length sides 54. Six triangles 48 are used to form the hexagon 53. The triangles used to form hexagon 53 may be a mixture of triangles 48 or 49 or all of the triangles could be triangles 49. The triangles are welded together to form hexagon 53 along weld lines 55, 56, and 57.

As illustrated in FIG. 3C, stamping occurs along dashed line circles 58, 59, and 60. A central scrap piece 61 results along with peripheral scrap pieces 62 indicated by slant lines.

As shown in FIGS. 3D and 3E, a stator 63 and a rotor 64 result from stamping on the aforementioned dashed line circles 58, 59, and 60. Parts of the weld lines 55, 56, and 57 may be observed in the stator 63 and rotor 64.

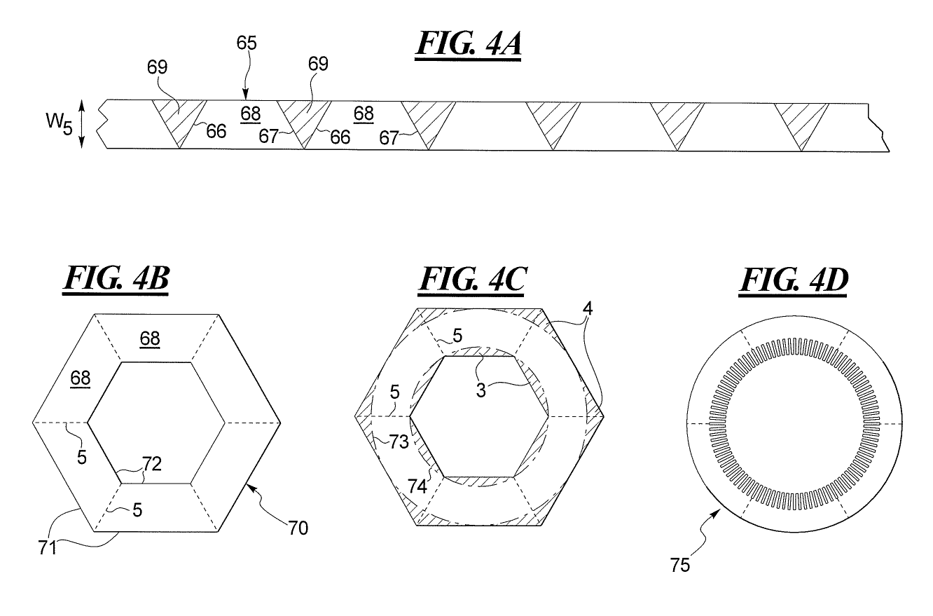

A fourth embodiment will now be described with reference to FIGS. 4A-4D. As illustrated in FIG. 4A, a strip 65 has slant cuts 66 and 67 to create segments comprising trapezoids 68 which are identical to each other. Relatively small scrap regions 69 are discarded. The width W₅ of strip 65 corresponds to a height of the trapezoids 68.

As shown in FIG. 4B, the trapezoids 68 are arranged in a circle to form a hexagon 70 having six equal length sides 71. Unlike the previous embodiments, a central open aperture is formed inside of the hexagon by the short equal length sides 72.

Weld lines 5 resulting from the slant cuts 66 and 67 are also shown in FIG. 4B. The six hexagons are thus welded together at the weld lines 5.

As illustrated in FIG. 4C, two dashed line circles 73 and 74 are defined to create the stator 75 illustrated in FIG. 4D. Scrap regions 3 and 4 result. Unlike the first three embodiments, only a stator is stamped out of the hexagon 70.

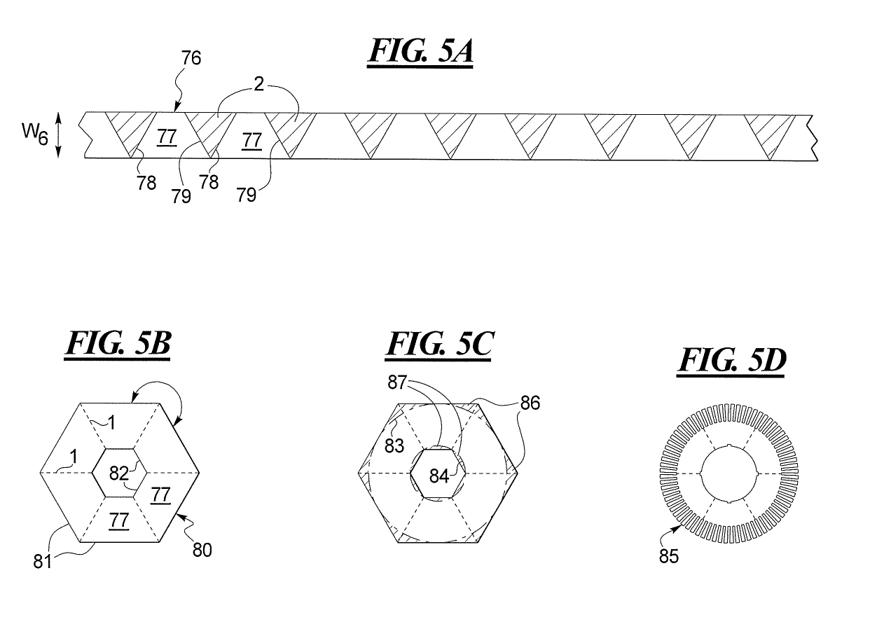

A fifth embodiment is illustrated in FIGS. 5A-5D. Here a strip 76 is provided in which segments comprising equal size trapezoids 77 result from cut lines 78 and 79. A width W₆ of the strip 76 matches a height of the trapezoids 77. Resulting scrap regions 2 are discarded.

As shown in FIG. 5B, a hexagon 80 having six equal length sides 81 is formed by welding together the six trapezoids at weld lines 1 formed at cut lines 78 and 79. A central blank region is formed bounded by short equal length sides 82 of the trapezoids 80.

As shown in FIG. 5C, dashed line stamping circles 83 and 84 are provided to create a rotor 85 as shown in FIG. 5D. Weld lines in the finished rotor 85 resulting from the weld lines 1 can be seen. Outer scrap regions 86 and inner scrap regions 87 are also illustrated.

As may be observed in the above five embodiments, in each case an equal side hexagon was formed. It is of course possible, and within the scope of this invention, to use other polygons instead of a hexagon. Thus such as eight-sided, ten-sided, twelve-sided, etc. polygons could be formed in an analogous manner as indicated above.

It should further be appreciated that in the five exemplary embodiments, at least three or more pieces are used to form the hexagons, which may be generically described herein as polygons.

Although preferred exemplary embodiments are shown and described in detail in the drawings and in the preceding specification, they should be viewed as purely exemplary and not as limiting the invention. It is noted that only preferred exemplary embodiments are shown and described, and all variations and modifications that presently or in the future lie within the protective scope of the invention should be protected.

I claim as my invention:

1. A method for forming at least one of a circular rotor or stator lamination, comprising the steps of:
providing at least one or two electrical steel strips of lamination material;
cutting the at least one or two strips into segments;
connecting at least three of the segments together to form a polygon having all equal sides; and
stamping the polygon along at least two circles to form the rotor or the stator.

2. The method of claim 1 wherein the polygon is stamped along three circles to form both a rotor and a stator.

3. The method of claim 1 wherein the segments are joined together by welding adjacent cut lines.

4. The method of claim 1 wherein the polygon is a hexagon with six equal length sides.

5. The method of claim 4 wherein the hexagon is formed of a rectangle and two triangles.

6. The method of claim 5 wherein the two triangles have two 30° angles and a 120° angle.

7. The method of claim 1 wherein two strips are provided, one strip being cut into equal rectangles and the other strip being cut into equal triangles, and wherein two of the triangles and one of the rectangles are used for creating a hexagon with six equal sides.

8. The method of claim 1 wherein the at least one strip is cut into trapezoids and the trapezoids are used to form a hexagon with six equal sides.

9. The method of claim 8 wherein the second strip is also cut into trapezoids where the trapezoids of the second strip are longer in length than the trapezoids of the one strip, and two of the shorter length trapezoids and two of the longer length trapezoids are assembled and joined together to form a hexagon with six equal sides.

10. The method of claim 1 wherein the one strip is cut to create equal triangles each having included three equal 60° angles, and six of the triangles are connected together to form a hexagon having six equal length sides.

11. The method of claim 1 wherein the one strip is cut to create equal trapezoids and six of the trapezoids are connected together in a circle to form a hexagon having six equal length sides.

12. The method of claim 1 wherein the polygon comprises a hexagon with six sides of equal length and wherein at least one of said circles is tangent at six different points at a mid-point of each of said six equal length sides.

13. The method of claim 1 wherein the polygon is stamped along three circles to form both the rotor and the stator.

14. The method of claim 13 wherein a scrap piece is removed when the third circle is stamped.

15. A method for forming at least one of a circular rotor or stator lamination, comprising the steps of:
providing at least one or two electrical steel strips of lamination material;
cutting the at least one or two strips into segments;
connecting at least three of the segments together by welding to form a hexagon having six equal sides; and
stamping the hexagon along at least two circles to form the rotor or the stator.

16. A method for forming a circular rotor and a stator lamination, comprising the steps of:
providing two electrical steel strips of lamination material;
cutting the first strip into rectangles;
cutting the second strip into triangles;
arranging the strips to form a hexagon having all equal sides comprising two of the triangles and one of the rectangles;
connecting the two triangles with the rectangle in-between to form the hexagon; and
stamping the hexagon along three concentric circles to create the rotor and the stator.
